(19) United States
(12) Patent Application Publication
(10) Pub. No.: US 2023/0163598 A1
(43) Pub. Date: May 25, 2023

(54) MICROGRID SYSTEM FOR SOLAR WATER PUMPS

(71) Applicant: Enphase Energy, Inc., Petaluma, CA (US)

(72) Inventors: Fernando Rodriguez, Austin, TX (US); Rahul Mallik, Seattle, WA (US); Bikesh Kumar Jha, Bangalore (IN); Saravana Bharathi.M.K, Kadugudi (IN); Patrick Lyle Chapman, Austin, TX (US); Raghuveer R. Belur, Los Altos Hills, CA (US); Amirhossein Moeini, Austin, TX (US); Kshitij Agrawal, Cidco (IN); Bipin Kumar Gurunatha Jyothi, 's-Hertogenbosch (NL)

(21) Appl. No.: 17/992,560

(22) Filed: Nov. 22, 2022

Related U.S. Application Data
(60) Provisional application No. 63/283,036, filed on Nov. 24, 2021.

(51) Int. Cl. H02J 3/38; H02J 3/00

(52) U.S. Cl. CPC H02J 3/381; H02J 3/001; H02J 2300/24

(57) ABSTRACT

A microgrid system for water pumps is provided herein and includes a solar array comprising three independent branches and a first pair of photovoltaic modules and a second pair of photovoltaic modules on each of the three independent branches, each of the first pair photovoltaic modules and the second pair of photovoltaic modules connected by a corresponding single-phase inverter connected in series with each other and connected to a common controller configured to connect the first pair photovoltaic modules and the second pair of photovoltaic modules to a grid during a first mode of operation and connect the first pair photovoltaic modules and the second pair of photovoltaic modules to a water pump during a second mode of operation, different from the first mode of operation.

### CROSS-REFERENCE TO RELATED APPLICATIONS

The present application claims the benefit of and priority to U.S. Provisional Application Ser. No. 63/283,036, filed Nov. 24, 2021, the entire contents of which is incorporated herein by reference.

### BACKGROUND

### Field of the Disclosure

Embodiments of the present disclosure relate generally to methods and apparatus configured for use with water pumps and, in particular, to methods and apparatus that use single-phase microinverters in a three-phase configuration to provide microgrid output for solar water pumps.

### Description of the Related Art

Conventional solar irrigation systems are well known. For example, such systems, typically, comprise one or more solar pumps that can be configured to pump water to one or remote locations, e.g., farmlands or other irrigatable areas. In some instances, the solar power needed to operate the one or more pumps is seasonal, e.g., only needed during irrigation seasons. Thus, during the off-season, the solar power is not needed and often wasted. Additionally, during irrigation seasons, as it is not necessary to irrigate at all possible times, solar power is not used.

Therefore, the inventors provide herein improved methods and apparatus that use single-phase microinverters in a three-phase configuration to provide microgrid output for solar water pumps.

### SUMMARY

Methods and apparatus configured for use with water pumps are provided herein. In some embodiments, a microgrid system for water pumps comprises a solar array comprising three independent branches and a first pair of photovoltaic modules and a second pair of photovoltaic modules on each of the three independent branches, each of the first pair photovoltaic modules and the second pair of photovoltaic modules connected by a corresponding single-phase inverter connected in series with each other and connected to a common controller configured to connect the first pair photovoltaic modules and the second pair of photovoltaic modules to a grid during a first mode of operation and connect the first pair photovoltaic modules and the second pair of photovoltaic modules to a water pump during a second mode of operation, different from the first mode of operation.

In accordance with at least some embodiments, a method for supplying power to a water pump comprises a) determining if inverters are in an idle mode and no faults are present, b) if yes at a) sending PLC initialize command to the inverters, c) determining if the water pump is running in a correct phase sequence, and d) entering water pump run state and enabling a voltage/frequency (V/F) control of the water pump when yes at c).

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of a system in accordance with embodiments of the present disclosure;

FIG. 2 is a block diagram of a three-phase solar water pump system in accordance with embodiments of the present disclosure;

FIG. 3 is a partial schematic diagram of the three-phase solar water pump system of FIG. 2 in accordance with embodiments of the present disclosure;

FIG. 4 is a partial schematic diagram of the three-phase solar water pump system of FIG. 2 in accordance with embodiments of the present disclosure;

FIG. 5 is a graph of nominal total dynamic head, flow rate, and corresponding efficiency in accordance with embodiments of the present disclosure;

FIG. 6 illustrates curves for summer (hot) and winter (cold) in accordance with embodiments of the present disclosure;

FIG. 7 is a flowchart of a method for supplying power to a solar water pump in accordance with embodiments of the present disclosure;

FIG. 8 is diagram of control box configured for use with the three-phase solar water pump system of FIG. 2 in accordance with embodiments of the present disclosure; and

FIG. 9 is a state diagram of the startup sequence for a solar water pump in accordance with embodiments of the present disclosure.

### DETAILED DESCRIPTION

Embodiments of the present disclosure generally relate to methods and apparatus configured for use with solar water pumps. For example, methods and apparatus described herein use single-phase microinverters in a three-phase configuration to provide microgrid output for solar water pumps. In at least some embodiments, a system, for example, can comprise one or more solar panels, one or more microinverters, and control equipment, which can include a communications gateway or other suitable communication device. The system can be operable in two modes of operation, a first mode of operation (e.g., grid tied inverter mode, to produce power into a three-phase grid) and a second mode of operation (e.g., solar water pump mode (off-grid), to produce power for a three-phase submersible pump or any other type of pump).

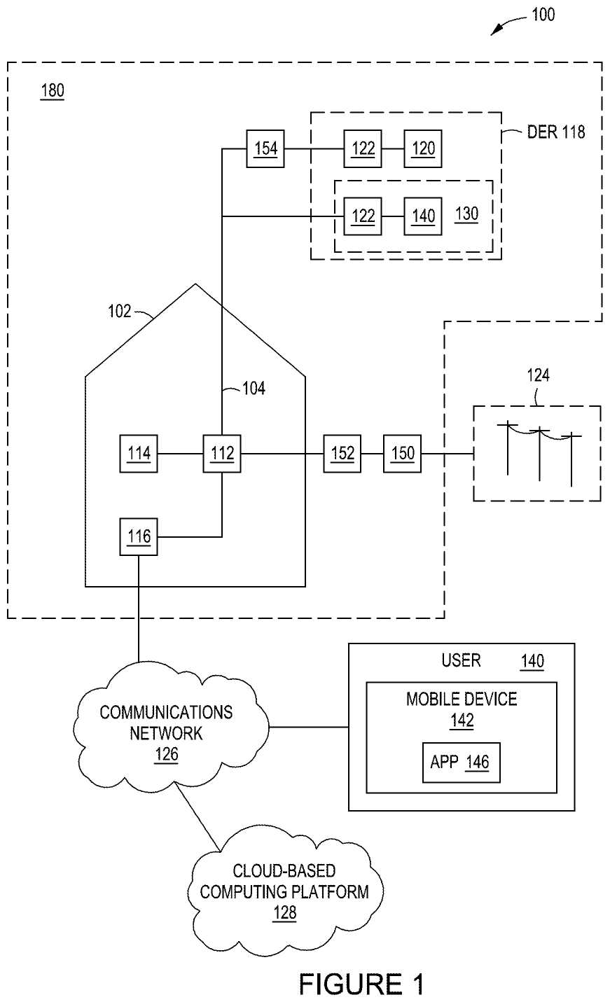

FIG. 1 is a block diagram of a system 100 (e.g., power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads and/or energy storage devices 114 (e.g., appliances, electric hot water heaters, thermostats/detectors, boilers, water pumps, and the like), which can be located within or outside the structure 102, and a DER controller 116, each coupled to a load center 112. Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 and a MID 150 (microgrid interconnect device), to a grid 124 (e.g., a commercial/utility power grid). The structure 102, the energy storage devices 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads (e.g., a solar pump) and/or the energy storage devices 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications, such as an application 146 (e.g., a grid connectivity control application) installed thereon for controlling the connectivity with the grid 124 as described herein. The application 146 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

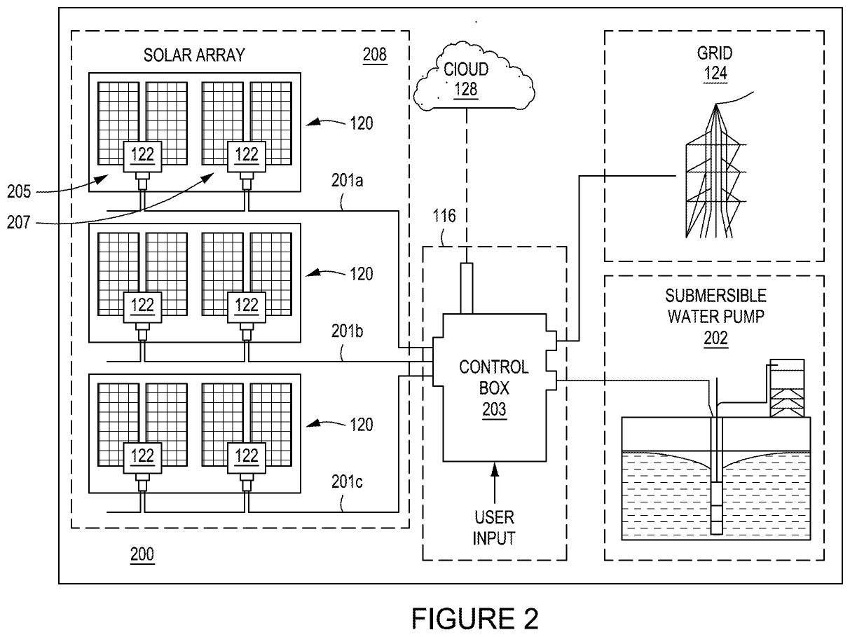

FIG. 2 is a block diagram of a system 200 (a three-phase water pump system) in accordance with embodiments of the present disclosure. The system 200 comprises a solar array 208 (e.g., the DER 118 comprising the RESs 120), a controller 203 (e.g., DER controller 116), a water pump 202 (e.g., a submersible water pump or other device suitable for use with the embodiments described herein), a grid (e.g., the grid 124), and an optional cloud-based computing platform (e.g., cloud-based computing platform 128).

Table 1 lists grid tied operating parameters of the system 200.

TABLE 1

| | |
|---|---|
| AC OUTPUT | 3-Ø, 4 Wire |
| TDH | <3% @ Nominal Power |
| DC/AC Ratio | up to 1.5 |

The system 200 is operable in two modes of operation. For example, as noted above, the system 200 can be operable in a first mode of operation (e.g., grid tied inverter mode, to produce power into a three-phase grid) and a second mode of operation (e.g., solar water pump mode (off-grid), to produce power for a three-phase submersible pump). In the second mode of operation, the system 200 is capable of producing power sufficient to meet various daily water output requirements demands (e.g., depending on season, as summer or winter). To operate in the two modes of operation, the solar array 208 can comprise six or more RESs 120. For example, the solar array 208 can comprise a plurality of two or more RESs connected by a conditioner (single power). In at least some embodiments, the solar array 208 can comprise three branches 201a-201c each comprising two pairs of RESs 205, 207 (e.g., a first pair of photovoltaics and a second pair of photovoltaics) connected by a power conditioner (single-phase). Thus, in the first mode of operation, all pairs of the RESs (e.g., RESs 205 and the RESs 207) in the three branches 201a-201c are configured to output to the grid, and in the second mode of operation all pairs of the RESs (e.g., RESs 205 and the RESs 207) in the three branches 201a-201c are configured to output to the water pump 202.

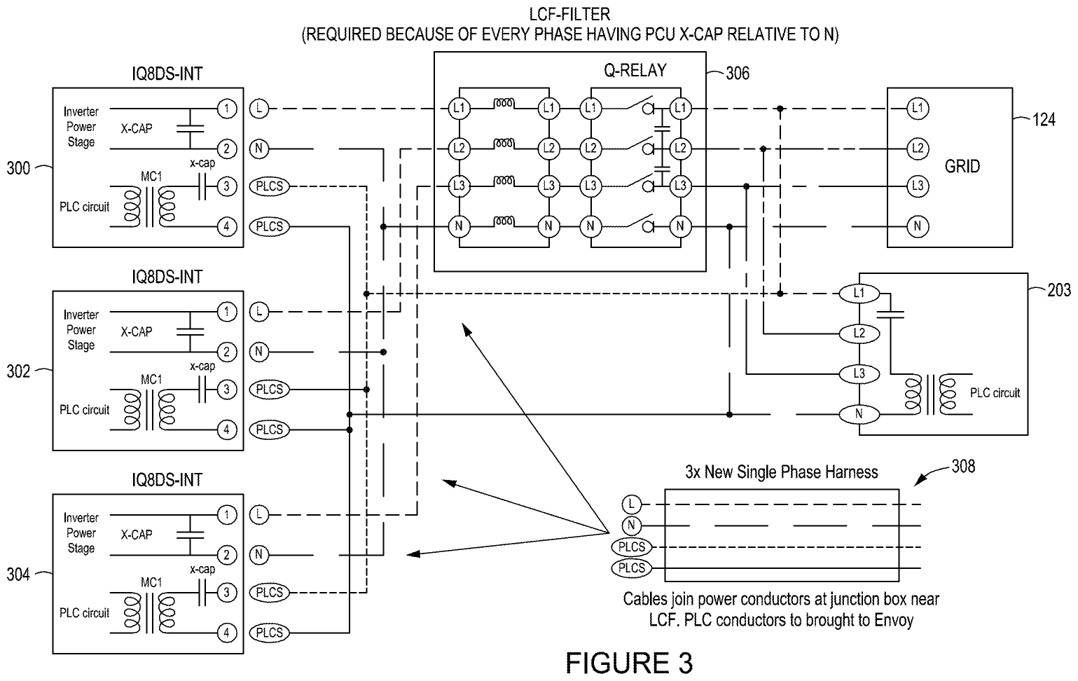

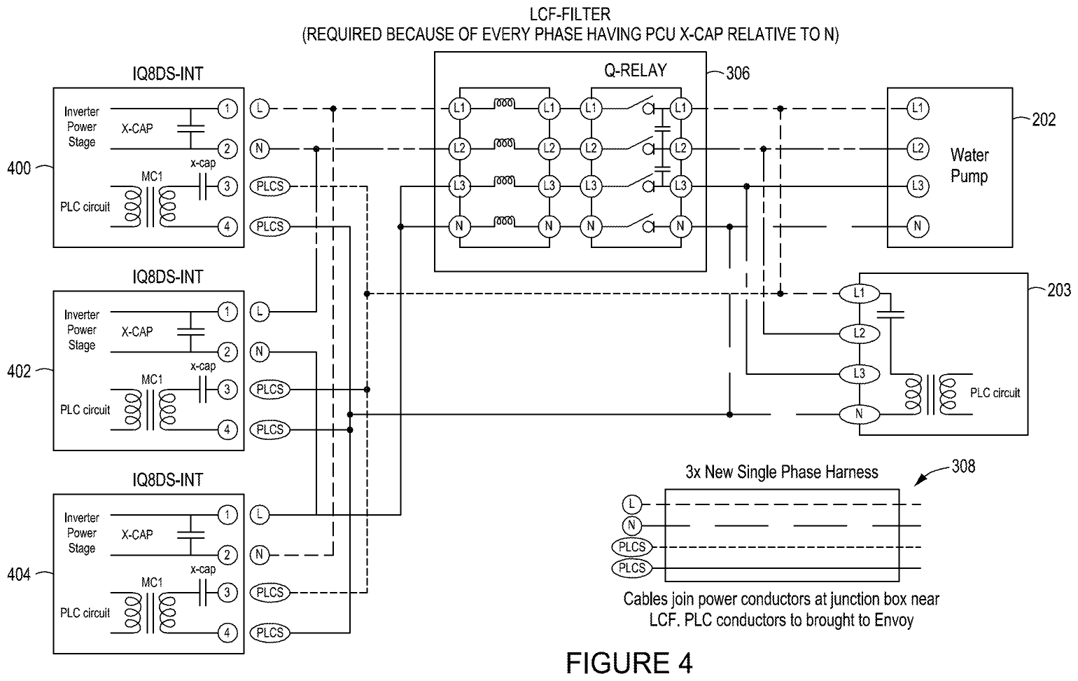

FIG. 3 is a partial schematic diagram of the system 200 in accordance with embodiments of the present disclosure. For example, each pair of RESs 205, 207 in the three branches 201a-201c are connected in series with each other, and the three branches 201a-201c connect to the controller 203. For example, a first power conditioner 300 can be connected to the pair of RESs 205 in the first branch 201a, a second power conditioner 302 can be connected to the pair of RESs 205 in the second branch 201b, a third power conditioner 304 can be connected to the pair of RESs 205 in the third branch 201c. For example, L and N outputs (load and neutral outputs) from the power conditioners 300-304 connect to corresponding inputs of an LCF filter 306, which includes one or more inductors, Q-relays, capacitors, or other suitable electronic device, and has outputs that connect to the grid 124 and the controller 203 (e.g., a gateway), as illustrated in FIG. 3. The LCF filter 306 can be a component of the controller 203 or a separate component therefrom. Similarly, PLC₁ and PLC₂ outputs (first power line communication and second power line communication outputs) from the power conditioners 300-304 connect to inputs of controller 203, as illustrated in FIG. 3. The wiring configuration of FIG. 3, which illustrates power conditioners 300-304 wired in Wye or Star configuration, allows the power conditioners 300-304 (single-phase) to operate in a three-phase configuration. Other wiring configurations can also be used to allow the power conditioners 300-304 (single-phase) to operate in a three-phase configuration. For example, as described in greater detail below, FIG. 4 shows power conditioners 400-404 wired in delta configuration which can also connect to a Grid.

A harness 308 (three-phase harness) can be used to house the cables (wires) used to connect the power conditioners 300-304, the LCF filter 306, the grid 124, and the controller 203 to each other.

FIG. 4 is a partial schematic diagram of the system 200 in accordance with embodiments of the present disclosure. For example, a first power conditioner 400 can be connected to the pair of RESs 207 in the first branch 201a, a second power conditioner 402 can be connected to the pair of RESs 207 in the second branch 201b, a third power conditioner 404 can be connected to the pair of RESs 207 in the third branch 201c. For example, L and N outputs (load and neutral outputs) from the power conditioners 400-404 connect to corresponding inputs of an LCF filter 406, which includes one or more inductors, Q-relays, capacitors, or other suitable electronic device, and has outputs that connect to the water pump 202 and the controller 203 (e.g., a gateway), as illustrated in FIG. 4. Similarly, PLC₁ and PLC₂ outputs (first power line communication and second power line communication outputs) from the power conditioners 400-404 connect to inputs of controller 203, as illustrated in FIG. 4. As with the wiring configuration of FIG. 3, the wiring configuration of FIG. 4 allows the power conditioners 400-404 (single-phase) to operate in a three-phase configuration.

The harness 308 can be used to house the cables (wires) used to connect the power conditioners 400-404, the LCF filter 406, the water pump 202, and the controller 203 to each other.

The water pump 202 can be any suitable poly-phase motor water pump (e.g., a 3 phase water pump). For example, a factor for determining a type of pump that can be used in accordance with the present disclosure can include a minimum amount of water that has to be pumped out every day, a motor-pump rating, and a total dynamic head. For example, in at least some embodiments, the water pump 202 can be a submersible pump having a 5 hp rating, a voltage of about 300 Vrms, a speed of about 2800 rpm to about 3000 rpm (e.g., about 2450 rpm), an efficiency of about 78%, and a power factor of about 0.78. Additionally, the water pump 202 can have a rated power of about 4 kW (hp) to about 5.5 kW (hp), a nominal total dynamic head of about 50 m, a nominal flow rate of about 280 lit/min, and a nominal efficiency of about 60%. In at least some embodiments, the water pump 202 can comprise a variable speed or single speed motor.

In at least some embodiments, to start the water pump 202 (e.g., a 5 hp water pump), a high start current may be required. Accordingly, the solar array 208 can comprise six RESs to ten RESs to start the pump. For example, in at least some embodiments, the solar array 208 can comprise six RESs, as illustrated in FIG. 2, e.g., a pair of RESs 207 in each of the three branches 201a-201c. Alternatively, in at least some embodiments, the solar array 208 can comprise 10 RESs, e.g., an extra pair of RESs 207 in a fourth branch (not shown). As the system 200 is a three phase system, typically, each phase comprises the same number of power conditioners 122. Thus, in at least some embodiments, the power conditioners can be implemented in sets of threes (3's). While the present disclosure shows 6 power conditioners (two (2) power conditioners per branch—201a, 201b, 201c), adding one more power conditioner per branch equates to nine (9) power conditioners, adding two power conditioners puts us at 12 and so on. To overcome the high starting current, however, in at least some embodiments one or more unbalance branches can be used, e.g., having a total number of power conditioners that is not a multiple of 3. Additionally, in at least some embodiments, the solar array 208 (e.g., six RESs to ten RESs) can produce 48,000 Wp (Watt-peak), which depending on a shut-off dynamic head (e.g., 50 m, 70 m, 100 m, etc.), can produce 100,800 liters/day (e.g., from a total head of 50 m), 67,200 liters/day (e.g., from a total head of 70 m), and 43,200 liters/day (e.g., from a total head of 100 m), respectively.

Table 2 lists the second mode of operation, e.g., water pump mode (off-grid) operating parameters.

TABLE 2

| Water Pump Power Rating | 5 | HP |
|---|---|---|
| Inverter Efficiency | 93% @ 80% of Rated power | |
| Output | 3-Ø, 3 Wire, R-Y-B, about 50 Hz | |
| Rated Motor Frequency (HZ) | 48-52 | |
| Frequency Operation | 0-52 Hz | (e.g., about 20 Hz ) |
| Voltage Operation | 0-240 V | (e.g., about 90 V) |
| Rated Motor Voltage | 230 | V |

| | |
|---|---|
| Motor Operation | Constant V/F |
| Output Characteristics | Filtered AC output voltage |
| Balance Supply | Phase Balancing: |
| Water Output | 21 liters of water per watt peak of PV |
| | array, from a Total Dynamic Head of 50 |
| | meter and the shut off head being at |
| | least 70 meter |

Some of the operating parameters of the controller 203 are listed in Table 2 to Table 5 below. For example, Table 3 lists monitoring and control operating parameters of the controller 203.

TABLE 3

| | |
|---|---|
| Parameters | Electrical Parameters (V, P), |
| | Generation, Liters/Day |
| Alarm | Fault - Dry Run, Short Circuit |
| Communication | GPRS/Bluetooth/Ethernet/WiFi |
| Customer Interface | Mobile App Based |
| Government Interface | Web Based |
| Service | Ticket Management through App |
| Control | Over The Air Firmware Upgrade |
| Additional Port | A Port for adding Irradiance |
| (Desired) | Sensor Data (Not Essential) |

Table 4 lists data and security operating parameters of the controller 203.

TABLE 4

| | |
|---|---|
| Storage | Local - 1 Year, Cloud - 5 years |
| Communication | Encrypted Communication TLS/SSL/X.509 |
| Authentication | Password Protection |
| Format of MSG (Preferred) | JSON |

Table 5 lists LCD operating parameters of the controller 203.

TABLE 5

| | |
|---|---|
| Items to display | Mode; Generation (Averaged); Electrical |
| | Parameters; and Fault feedback. |

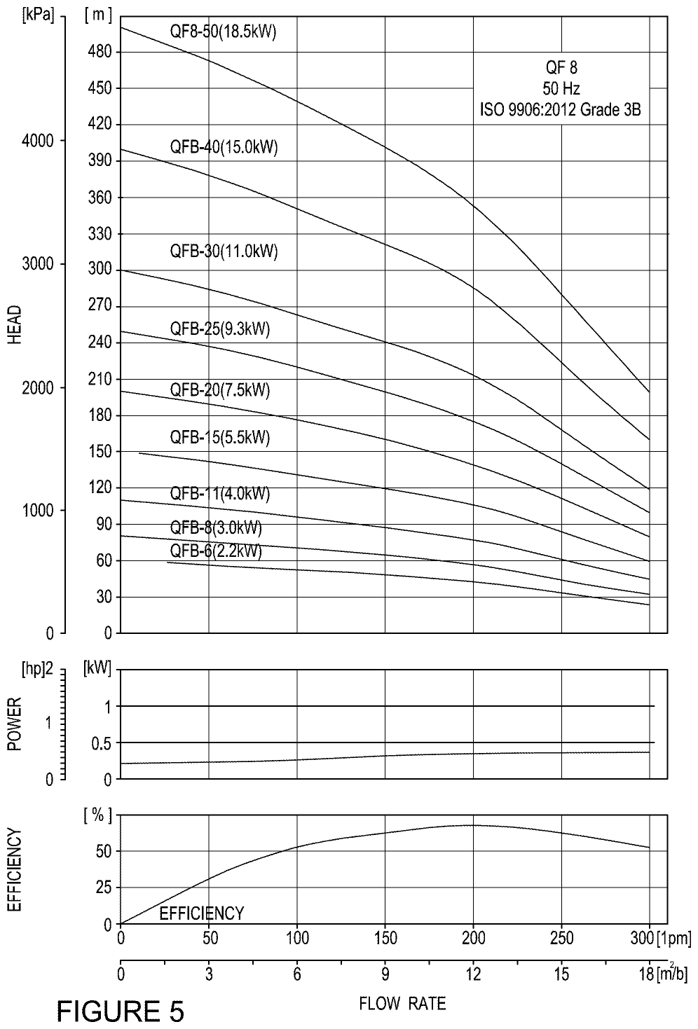

FIG. 5 is a graph of nominal total dynamic head, flow rate, and corresponding efficiency in accordance with embodiments of the present disclosure. For example, the data of FIG. 5 illustrates a water pump performance curve that is supplied by a water pump vendor, which can be used to estimate if the system 200 will be able to generate the water pumping requirement.

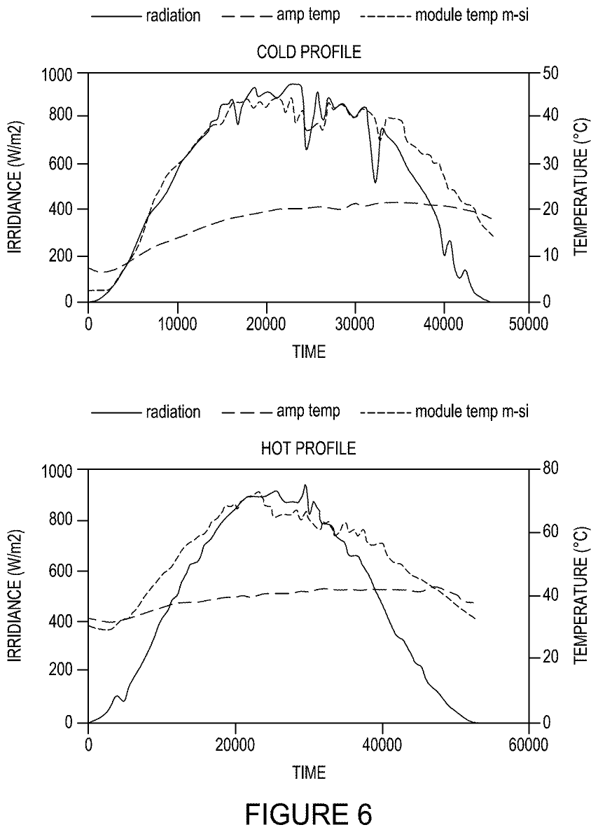

FIG. 6 illustrates curves for summer (hot) and winter (cold) in accordance with embodiments of the present disclosure. For example, the irradiation profiles of FIG. 6 (in conjunction with the performance curve in FIG. 5) are used to estimate the water production for the profile.

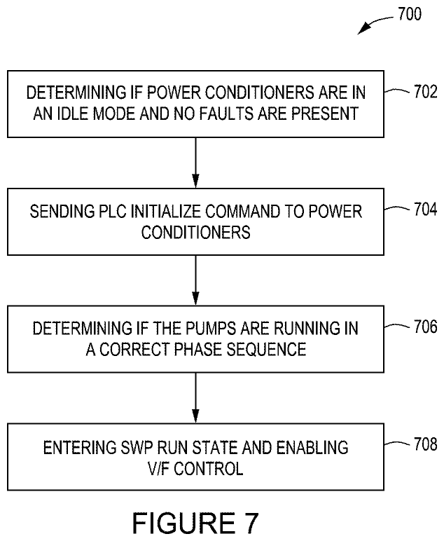

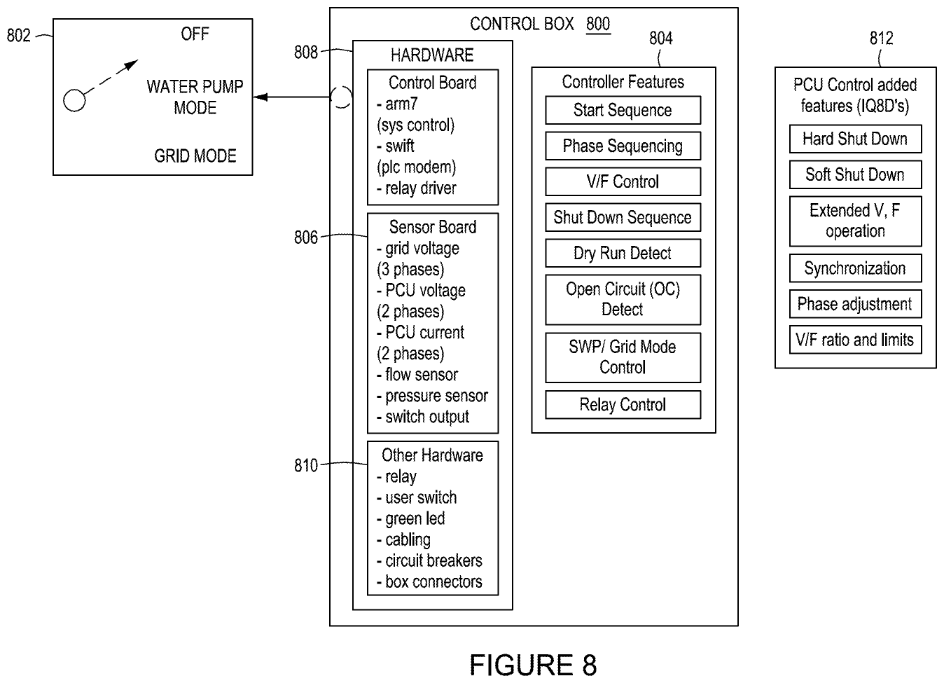

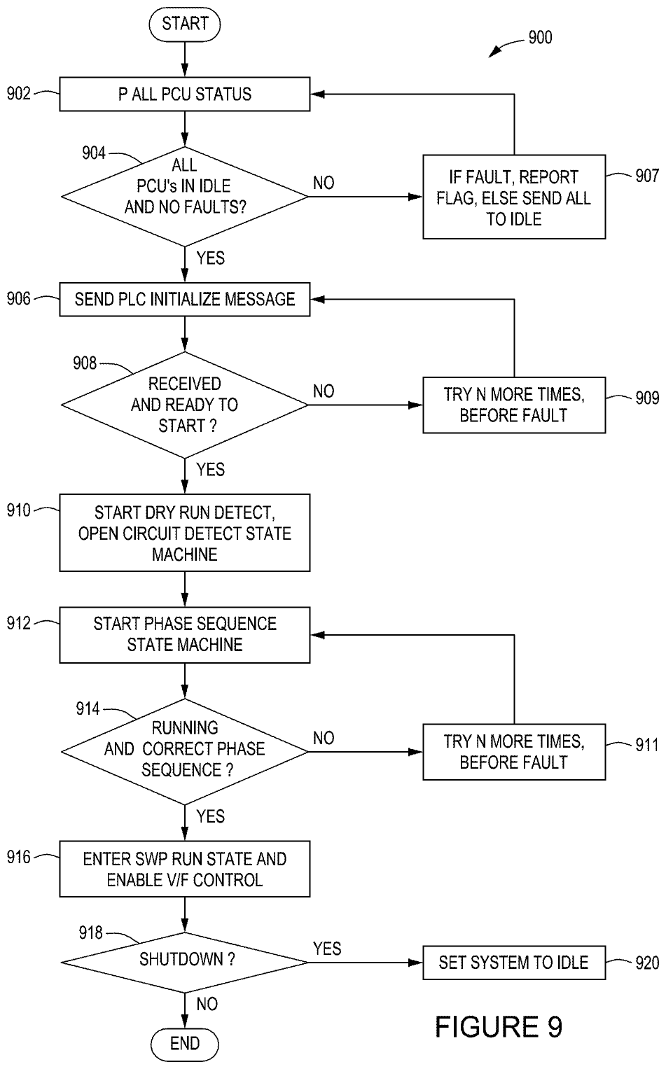

FIG. 7 is a flowchart of a method 700 for supplying power to a solar water pump, FIG. 8 is diagram of a control box 800 configured for use with the system 200 of FIG. 2, and FIG. 9 is a state diagram 900 of a startup sequence for a solar water pump in accordance with embodiments of the present disclosure.

For example, in at least some embodiments, a system (e.g., the system 200) comprises a switch 802 (manual switch) at the control box 800 (e.g., the controller 203), which comprises a plurality of sensors, relays, modems, controllers (e.g., similar to the DER controller 116), drivers, LEDs, circuit breakers, cabling, displays, etc. The manual switch will have three positions 1) OFF, 2) WATER PUMP MODE, and 3) GRID MODE. In the OFF position, the system 200 is idle (e.g., output power is de-energized). When a user turns the switch 802 to the WATER PUMP MODE, the control box 800 (via controller 804) actuates one or more relays 810 (included in hardware 808) inside the control box 800 to direct power to a water pump electrical output. For example, at 702, the method 700 comprises determining if power conditioners are in an idle mode and no faults are present (see FIGS. 9, at 902 and 904). If the power conditioners are in an idle mode and no faults are present, at 704, the method 700 comprises sending PLC initialize command (see FIG. 9, at 906) to the power conditioners. If a fault is present, a flag can be triggered and all power conditioners are placed in idle mode (see FIG. 9, at 907).

Next, in at least some embodiments, the method 700 can comprise determining if the DM (data module, which is a set of parameters used by the controller firmware) initialize values have been received at the power conditioners (see FIG. 9, at 908). If no at 908, the control box 800 can try “N” more times (e.g., a predetermined amount) before a fault is triggered (see FIG. 9, at 909). If yes at 908, next, the method 700 can comprise a start dry run detect, an open circuit detect, and/or a start phase sequence (see FIG. 9, at 910). For example, the control box 800 communicates with power conditioners (e.g., the power conditioner 122) via PLC to start water pump operation (e.g., the water pump 202). The power conditioners will begin a start-up routine to form a 3 phase grid at a low frequency and voltage (see FIG. 9, at 912).

Next, at 706, the method 700 comprises determining if the pumps are running in a correct phase sequence (see FIG. 9, at 914). For example, the control box 800 (via internal voltage and current sensors 806) determine if the 3 phase voltage phase sequence is correct and, if so, operation will continue. For example, in at least some embodiments, a correct phase sequence can correspond to the motor driving the water pump spinning in a correct direction. If no at 914, the system 200 will restart until the correct phase sequence is achieved (see FIG. 9, at 914).

Next, at 708, the method 700 comprises entering solar water pump (SWP) run state and enabling V/F control (see FIG. 9, at 916). For example, once the correct phase sequence is confirmed, the control box 800 periodically (e.g., a predetermined amount of times of about every 10 seconds) communicates with the power conditioners to implement/enable a voltage/frequency (V/F) control, e.g., a common induction motor control technique. For example, in the case of a water pump, in at least some embodiments, the power consumed (e.g., a maximum) by the water pump can be proportional to a cubed of the water pump shaft speed, which will be mostly proportional to the excitation electrical frequency. Therefore, the use of available PV power can be maximized by adjusting the excitation frequency generated by the power conditioners.

Next, when a user changes the switch 802 to GRID MODE, the system 200 will shut down and go to the idle state (see FIGS. 9, at 918 and 920, respectively), then the control box 800 will actuate internal relays to direct power to a grid port (e.g., not the SWP port). The control box 800 then communicates via PLC with the power conditioners to command the power conditioner to start producing power onto the Grid.

One or more additional features can be provided in a PCU control 812. For example, in at least some embodiments, the PCU control 812 can comprise hard shut down, soft shut down, extended V/F operation, synchronization, phase adjustment, V/F ratio and limits, etc.

While the foregoing is directed to embodiments of the present disclosure, other and further embodiments of the disclosure may be devised without departing from the basic scope thereof, and the scope thereof is determined by the claims that follow.

What is claimed is:

1. A microgrid system for water pumps, comprising:
a solar array comprising three independent branches; and
a first pair of photovoltaic modules and a second pair of photovoltaic modules on each of the three independent branches, each of the first pair photovoltaic modules and the second pair of photovoltaic modules connected by a corresponding single-phase inverter connected in series with each other and connected to a common controller configured to connect the first pair photovoltaic modules and the second pair of photovoltaic modules to a grid during a first mode of operation and connect the first pair photovoltaic modules and the second pair of photovoltaic modules to a water pump during a second mode of operation, different from the first mode of operation.

2. The microgrid system of claim 1, wherein the first mode of operation is a grid on mode configured to produce power into a three-phase grid.

3. The microgrid system of claim 1, wherein the second mode of operation is a water pump mode configured to produce power for the water pump.

4. The microgrid system of claim 1, wherein the water pump is a three-phase submersible pump.

5. The microgrid system of claim 1, wherein the single-phase inverter that connects to the first pair of photovoltaic modules comprises:
load and neutral outputs that connect to corresponding inputs of an LCF filter that has outputs that connect to the grid and the common controller; and
first power line communication and second power line communication outputs that connect to the common controller.

6. The microgrid system of claim 1, wherein the single-phase inverter that connects to the second pair of photovoltaic modules comprises:
load and neutral outputs that connect to corresponding inputs of an LCF filter that has outputs that connect to the water pump and the common controller; and
first power line communication and second power line communication outputs that connect to the common controller.

7. The microgrid system of claim 1, wherein the single-phase inverter that connects the first pair of photovoltaic modules to each other and the single-phase inverter that connects the second pair of photovoltaic modules to each other are wired in one of a Wye or Star configuration.

8. The microgrid system of claim 1, further comprising a three-phase harness that is configured to house cables that connect to the single-phase inverter that connects to the first pair of photovoltaic modules, the single-phase inverter that connects to second pair of photovoltaic modules, an LCF filter, the grid, and the common controller.

9. The microgrid system of claim 1, wherein the common controller comprises a manual switch having three positions 1) OFF, 2) WATER PUMP MODE, and 3) GRID MODE.

10. The microgrid system of claim 1, wherein the common controller is further configured to:
send PLC initialize command to the single-phase inverter that connects to the first pair of photovoltaic modules and the single-phase inverter that connects to the second pair of photovoltaic modules when no fault is present; and
trigger a flag and place the single-phase inverter that connects to the first pair of photovoltaic modules and the single-phase inverter that connects to the second pair of photovoltaic modules in an idle mode when a fault is present.

11. A method for supplying power to a water pump, comprising:
a) determining if inverters are in an idle mode and no faults are present;
b) if yes at a) sending power line communication (PLC) initialize command to the inverters;
c) determining if the water pump is running in a correct phase sequence; and
d) entering water pump run state and enabling a voltage/frequency (V/F) control of the water pump when yes at c).

12. The method of claim 11, after c) further comprising e) determining if the PLC initialize command has been received at the inverters.

13. The method of claim 12, wherein if no at e) further comprising f) resending the PLC initialize command to the inverters for a predetermined amount of times and triggering a fault when the predetermined amount of times is reached.

14. The method of claim 12, wherein if yes at e) further comprising g) at least one of starting a dry run detect, starting an open circuit detect, or a start phase sequence.

15. The method of claim 11, wherein c) comprises determining if a motor driving the water pump is spinning in a correct direction.

16. The method of claim 11, wherein d) further comprises periodically communicating with the inverters to continue enabling the voltage/frequency (V/F) control of the water pump.

17. The method of claim 16, wherein periodically communicating with the inverters is performed about every 10 seconds.

18. The method of claim 11, wherein enabling the voltage/frequency (V/F) control of the water pump comprises adjusting an excitation frequency generated by the inverters so that power available for the water pump is a maximum.

19. The method of claim 18, wherein the excitation frequency is adjusted to about a cubed of a water pump shaft speed.

20. The method of claim 11, further comprising h) determining if the inverters are in a grid mode and if yes i) communicating via PLC with the inverters to start producing power onto a grid.
